(19) United States
(12) Patent Application Publication
(10) Pub. No.: US 2006/0056648 A1
(43) Pub. Date: Mar. 16, 2006

(54) Method for manufacturing a carrier element for a hearing aid and a carrier element for a hearing aid

(75) Inventor: Morten Linkenkaer-Hansen, Vaerlose (DK)

Correspondence Address: SUGHRUE MION, PLLC, 2100 PENNSYLVANIA AVENUE, N.W., SUITE 800, WASHINGTON, DC, 20037, US

(73) Assignee: WIDEX A/S

(21) Appl. No.: 11/268,619

(22) Filed: Nov. 8, 2005

Related U.S. Application Data
(63) Continuation-in-part of application No. PCT/DK03/00307, filed on May 9, 2003.

(51) Int. Cl. H04R 25/00

(52) U.S. Cl. 381/324; 381/322

(57) ABSTRACT

A method for manufacturing a carrier element for a hearing aid said method comprising the steps of providing a substantially flat conducting structure (1), moulding a plastic material around selected areas of said structure leaving at least one gap (81, 82) bridged by said substantially flat conducting structure, and permanently deforming said substantially flat structure by bending it along said at least one gap. The invention further provides a carrier element for at hearing aid.

### RELATED APPLICATIONS

The present application is a continuation-in-part of application No. PCT/DK2003/000307; filed on 9 May 2003, in Denmark and published as WO 2004/100606 A1.

### BACKGROUND OF THE INVENTION

1. Filed of the Invention

The present invention generally relates to hearing aids. The invention more specially relates to a method for manufacturing a carrier element for a hearing aid and to a carrier element for a hearing aid.

2. The Prior Art

Modern hearing aids have very small dimensions. Hence, the internal space has to be utilized efficiently. Moreover, the small dimensions complicate the use of sub-assemblies, groups of components or similar modular parts. Though modular parts may be made to fit inside the hearing aid housing, they suffer from the drawback that they need to be interconnected electrically, e.g. by soldering, which in turn involves rather delicate manual work.

To overcome these problems it has been suggested to use groups of components mounted on flexible circuit boards. Examples of such flexible circuit boards are found in e.g. U.S. Pat. No. 6,456,720 and U.S. Pat. No. 4,710,961.

Flexible circuit boards, however, leave much to be desired in terms of ruggedness and durability. In particular, the rather harsh humid environment existing in or at the ear where hearing aids are worn, severely affects the flexible circuit giving it a too short life compared to the remainder of the components of the hearing aid.

DE-A-3842572 discloses a method for manufacturing a carrier element for a hearing aid. The carrier element is manufactured from a substantially flat sheet of metal, e.g. by etching or punching, forming a comb structure.

It is the object of the invention to overcome the above problems in hearing aids in terms of utilisation of internal space of the hearing aid and facilitating the manufacturing operations without compromising the durability of the hearing aid.

### SUMMARY OF THE INVENTION

According to a first aspect of the invention, this object is achieved by a method for manufacturing a carrier element for a hearing aid, said method comprising the steps of providing a substantially flat conducting structure, moulding a plastic material around selected areas of said structure leaving at least one gap bridged by said substantially flat conducting structure, and permanently deforming said substantially flat structure by bending it along said at least one gap.

According to a second aspect of the invention the object is achieved by a carrier element for a hearing aid manufactured by providing a substantially flat conducting structure, moulding a plastic material around selected areas of said structure leaving at least one gap bridged by said substantially flat conducting structure, and permanently deforming said substantially flat structure by bending it along said at least one gap.

Thereby a rugged carrier element, which better utilizes the internal spacing in the hearing aid, is obtained. Moreover the carrier element allows for reduction in the number of leads and wires, which need to be connected by soldering or similar between various components or groups of components. The carrier element provides a structural member, which serves as a convenient platform during stages of assembly of the hearing aid.

In an embodiment, moulding of a plastic material around selected areas of said structure leaves a further part of said substantially flat conducting structure protruding from at least one of said areas. This facilitates connections among components or groups of components, e.g. by means of soldered wires.

According to a preferred embodiment said further part is permanently deformed to form a tab for contacting and holding a battery.

By forming the battery tabs as an integral part of the carrier element, short distances between the power supply and the power consumers may be achieved, thereby reducing losses and undesirable voltage drops.

In another preferred embodiment said further part is permanently deformed to form a connection pad. This is advantageous, as, depending on the circumstances, connection pads may be arranged in such a way on the carrier element, that wire connections to other parts, such as the processing chip, mounted on said carrier, are avoided. That is, the external contacts of the chip may be connected directly to the connection pads without intermediate wires.

According to another embodiment of the invention the method further comprises the preceding step of forming said substantially flat structure from a blank by etching. Etching is presently preferred over other methods such as punching or laser cutting, which require a relatively large set-up, e.g. punching tools, that may be too costly for smaller production batches. For larger production runs punching is preferred.

In a preferred embodiment of the carrier element according to the second aspect of the invention, the carrier element comprises a further part of said substantially flat conducting structure protruding from at least one of said areas and arranged so as to form a fixed contact of a switch. Preferably, in that case the plastic material around at least one of said selected areas of the structure comprises a fulcrum for a switch operating element.

According a further preferred embodiment said plastic material around at least one of said selected areas of the structure comprises a plane surface. This plane surface provides suitable accommodation for an electronics module such as a block containing inter alia the processing chip, to be mounted on the carrier by e.g. gluing or soldering. Preferably, at least one connection pad is arranged in the vicinity of the plane surface so as to allow it to contact a terminal of an electronics module mounted on said surface. Thereby, contact can be made between the carrier element and the electronics module without the use of additional wiring.

According to yet another preferred embodiment the plastic material around at least one of said selected areas of the structure comprises a surface provided with recesses exposing partially said conducting structure. This allows the access to the conductive structure by means of contacts in the form of pins. Thus temporary electrical connection for e.g. programming purposes or to auxiliary add-on modules can be made. Preferably, in that case said plastic material around at least one of said selected areas of the structure comprises a surface adapted to form part of the housing of a hearing aid. This then allows direct external access to the hearing aid processor for e.g. programming purposes, when the hearing aid is in an assembled condition.

### BRIEF DESCRIPTION OF THE DRAWINGS

The invention will now be explained in greater detail with reference to a non-limiting exemplary embodiment illustrated on the schematic drawings. In the drawings,

FIG. 1 shows an original blank with the conductive structure of the carrier,

FIG. 2 shows the blank after parts of conductive structure have been deformed,

FIG. 3 shows the finished blank with the conductive structure after moulding, but before severing the conductive structure from the remainder of the blank from which it has been etched

FIG. 4 shows the conductive structure after moulding according to FIG. 3, but after severing the conductive structure from the remainder of the blank from which it has been etched,

FIG. 5 shows a top plan view of the conductive structure after moulding according to FIG. 3,

FIG. 6 shows an view of the conductive structure of FIG. 5,

FIG. 7 shows a side view of the conductive structure according to FIG. 5,

FIG. 8 shows a cross sectional view taken along the line VIII-VIII in FIG. 5,

FIG. 9 shows the severed conductive structure of FIG. 4 after it has been bent into its final shape,

FIG. 10 shows the conductive structure of FIG. 9 after a rocker switch and an electronics module have been fitted,

FIG. 11 shows the conductive structure of FIG. 10 after it has been placed in position in a housing part of a hearing aid side, and

FIG. 12 shows the finished hearing aid with the conductive structure in place and a combined battery compartment and switch mounted.

### DETAILED DESCRIPTION OF THE INVENTION

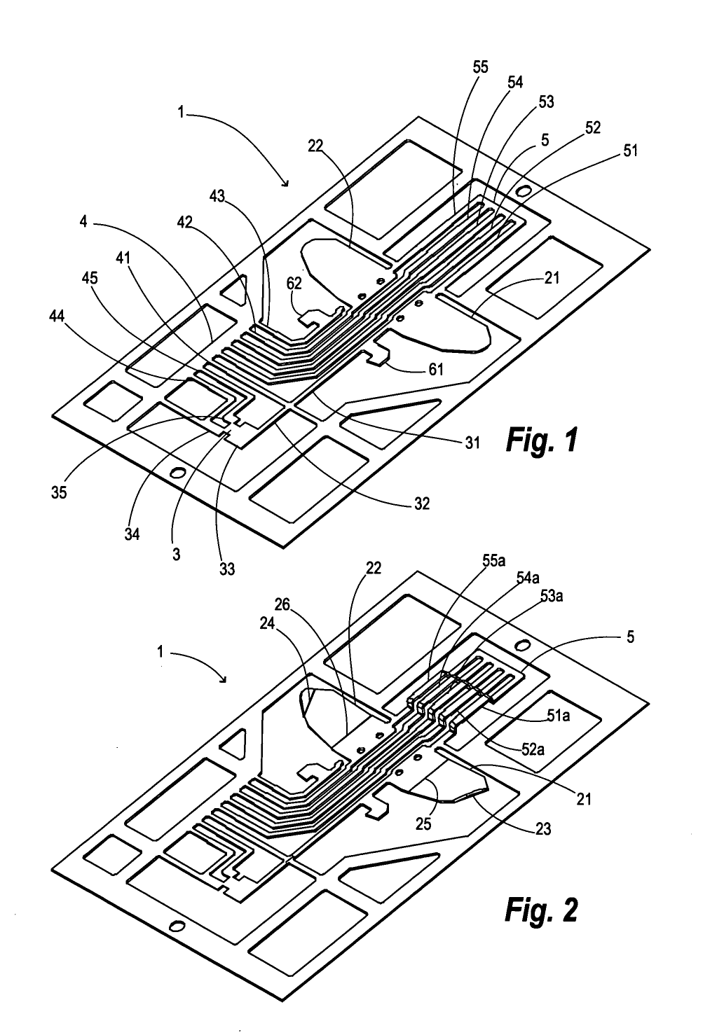

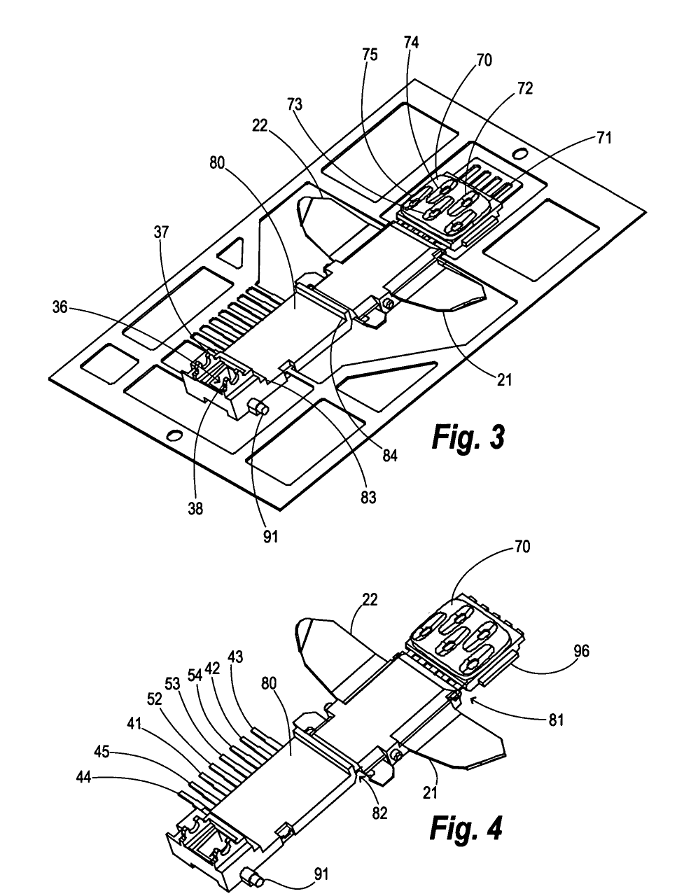

FIG. 1 shows a plane conductive structure 1. The conductive structure comprises two wing-like elments or lobes 21 and 22, which are to serve as battery tabs. The conductive structure 1 furthermore comprises a first, a second and a third bridge 3, 4, 5 serving to hold the various webs or conductors of the conductive structure 1 in a predetermined configuration until they are later secured by the plastic material to be moulded around certain areas of the conductive structure 1, as shown in FIG. 3. After the plastic material has been moulded around the conductive structure, these bridges 3, 4, 5 may be severed or broken away as illustrated in FIG. 4, thus converting the webs into a number of conductors without mutual electrical interconnetions.

From the third bridge 5 five conductors 51-55 extend. Two of the conductors 51 and 55 are connected to the second bridge 4 via the battery tabs 21, 22 and further conductors 31, 41 and 42, respectively, whereas the remaining three conductors 52, 53, 54 extend directly to the second bridge 4.

From the battery tab 21 the conductor 31 branches into the already mentioned conductor 41, leading to the second bridge 4, and into a conductor 32, leading to the first bridge 3. From the first bridge 3 two conductors 44 and 45 lead to the second bridge 4. Around the first bridge 3 the respective conductors 32, 44, 45 have slightly enlarged areas 33, 34 and 35, respectively, which, once the first bridge 3 has been severed, form the fixed contacts of a bridging rocker switch, the handle of which is seen in FIG. 10, for the volume control of the hearing aid.

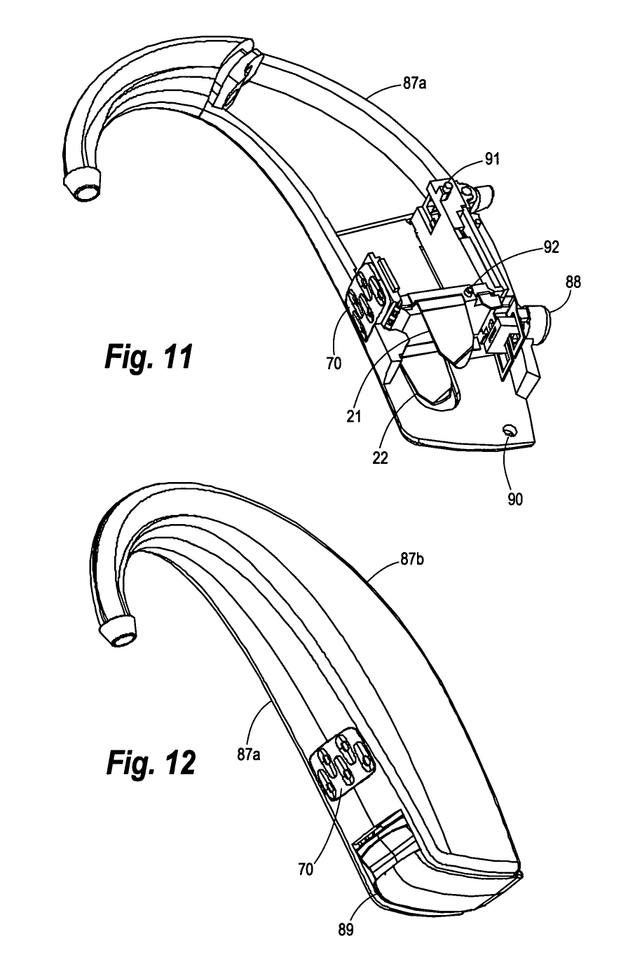

On the conductor 31 a further fixed contact lobe 61 is formed. This fixed contact lobe 61 has a counterpart fixed contact lobe 62 connected to the second bridge 4 via a conductor 43. These fixed contact lobes cooperate with a bridge contact of a programme selector switch, such as a push-button switch 88 mounted in the housing of the hearing aid, as seen in FIG. 11.

In FIG. 2 the conductors 51-55 have been deformed in such a way that raised portions 51a-55a have been formed. Also, the battery tabs 21, 22 have been deformed slightly at respective bends 23, 24 and 25, 26. This is preferably done together with deformation of the conductors 51-55, but it could also take place after a subsequent moulding stage.

In FIG. 3 the conductive structure is shown after this subsequent moulding stage, where plastic material has been moulded around the conductive structure in selected areas. The plastic material around the raised portions of 51a-55a of the conductors 51-55 has an upper surface 70. In the upper surface 70 a number of recesses 71-75 corresponding to respective raised portions 51a-55a of the conductors 51-55 are provided. The conductors are accessible through said recesses 71-75. As best seen in FIG. 12, the upper surface 70 will form part of the hearing aid housing, in which it is later to be mounted, and the conductors will thus be externally accessible for programming purposes or for add-on auxiliary modules, such as an FM radio receiver unit, e.g. for places where no loop system is available. Such a module could then be supplied with power from the hearing aid battery via the conductors 51 and 55, whereas the received information would be communicated to the electronics module 85 (illustrated in FIG. 10) via one or more of the conductors 52-54.

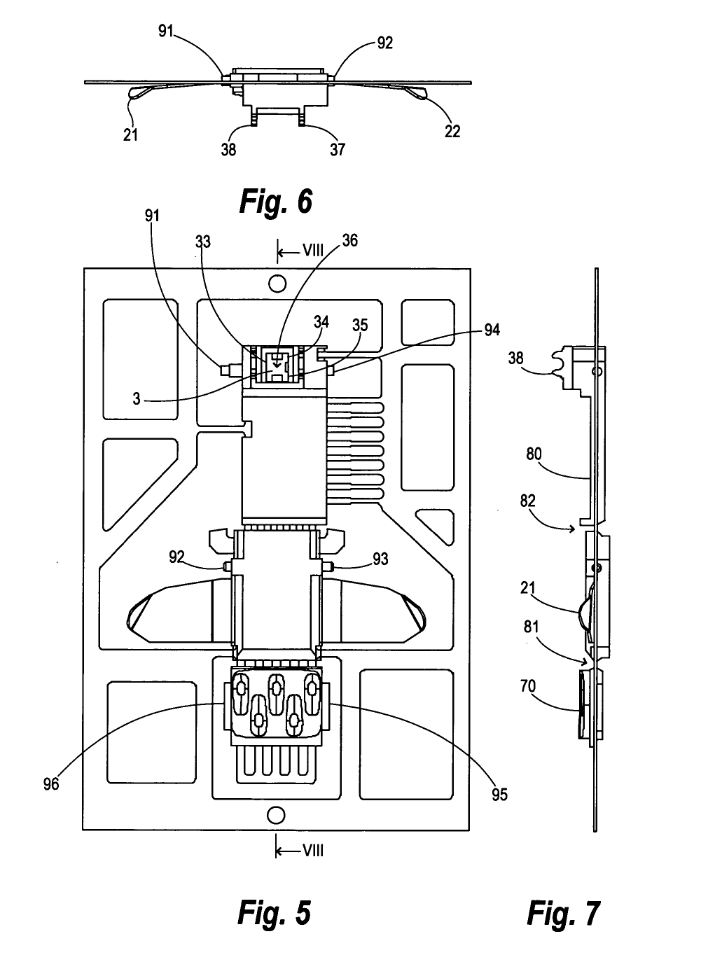

Reference is again made to FIG. 3. For the accommodation of the electronics module 85 a generally flat surface 80 is provided on the plastic material moulded around another area of the conductive structure. The substantially flat surface is delimited at two ends by means of walls 83, 84. These walls serve as base for the positioning of the electronics module 85, when it is placed over the flat surface 80 on the end walls 83 and 84 and secured thereto by means of e.g. glue. On the other side of the wall 83 away from the flat surface 80 there is provided an aperture 36 in the plastic material. As best seen in FIG. 5, this aperture 36 allows access to the fixed contacts 33, 34, 35. On two sides of the aperture two uprights 37, 38 of a fulcrum are provided. On the fulcrum the rocker carrying the contact bridge of a rocker switch 86 bridging pairs of the fixed contacts 33/34 and 33/35, respectively, is to be located. Via the rocker switch 86 selective connections, serving as indication for volume up and volume down for the electronics module 85, may be established between the conductors 44 and 45.

In FIG. 4 the conductive structure has been severed from the remainder of the blank. The ends of the conductors 41, 42, 43, 44, 45, 52, 53 and 54 are cut at a distance from the plastic material so that they protrude from it.

In FIG. 9 the conductive structure after a subsequent bending step is illustrated. As can be seen the ends of the conductors 41, 42, 43, 44, 45, 52, 53 and 54 are bent over the flat surface 80. The ends thus form connection pads, to which terminals of the electronics module 85 may be directly connected without intermediate flexible leads, as illustrated in FIG. 10. This could be done by means of soldering or conductive gluing or by any other appropriate means known in the art. As also seen in FIG. 9 the conductive structure is bent at the bending zones 81 and 82 in order to configure the conductive structure. The bending zones 81 and 82 are those areas of the conductors that have been left uncovered between the areas around which the plastic material has been moulded.

In FIG. 9 is also seen that the lobes 21, 22 and 61, 62 have been bent. The conductive structure has thus been bent into its final shape to form a carrier element, which will fit in the hearing aid housing as a part thereof.

As mentioned above and as best seen in FIG. 11, the upper surface 70 of the plastic material covering one of the areas forms part of the housing of the hearing aid. The housing typically consists of two halves or shells 87a, 87b. In order to facilitate correct positioning of the shells and the part with the surface 70 relatively to each other a number of generally cylindrical projections 91, 92, or guide pins 93, 94, and other projections 95, 96, best seen in the top view of FIG. 5 are formed from the plastic material.

In FIGS. 1, 2, 5, 6 and 7 it is illustrated how the conductive structure is formed starting from a larger blank. The blank is preferably etched, but may just as well be provided by other means such as punching or laser-cutting. Although the figures illustrate a single blank, the skilled person will appreciate that the blank may be provided as a part of a strip, a band or an array of identical blanks.

FIGS. 5, 6 and 7 are respective top, end and side views, of the blank with the conductive structure after moulding but prior to severing.

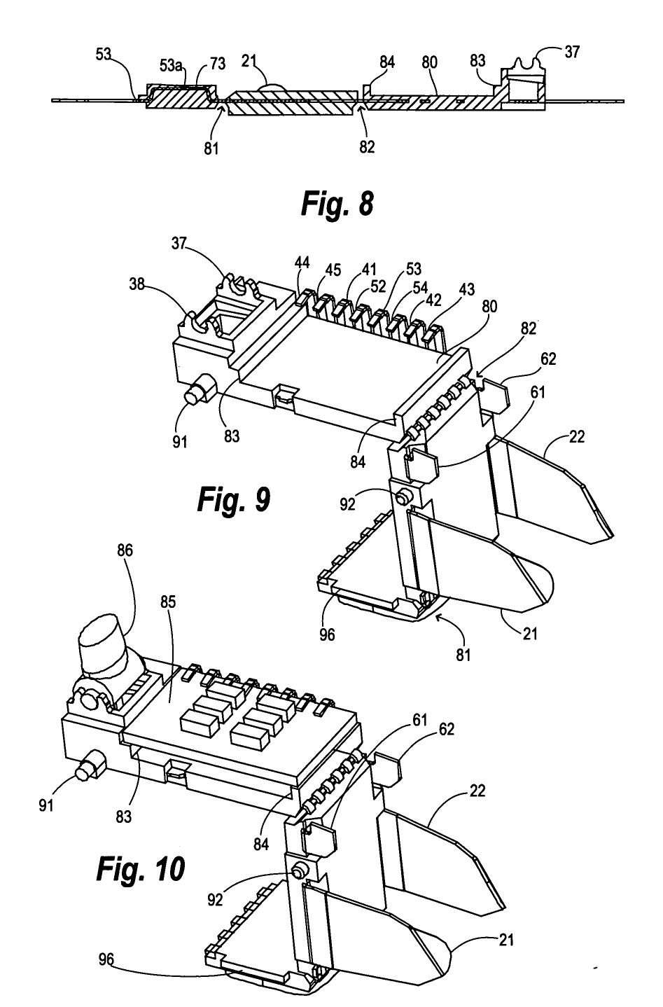

FIG. 8 is a cross section taken along the line VIII-VIII in FIG. 5. FIG. 8 illustrates how the conductor 53 has a bent portion 53a where it approximates the upper surface 70, so as to be readily accessible at the bottom of the recess 73. The other four conductors 51, 52, 54, 55 have corresponding bends in order to be readily accessible in their respective recesses 71, 72, 74, 75, as illustrated in FIG. 2.

As will be understood from the above, FIGS. 1-4, 9 and 10 illustrate stages in a manufacturing process for a carrier element according to the invention.

Thus in FIG. 1 there is provided a substantially flat conducting structure 1. The conducting structure is preferably provided by means of etching from a metal sheet.

From this situation the substantially flat structure 1 is slightly deformed to form the raised portions 51a-55a of the conductors 51-55. Also the lobes 21 and 22 are deformed along the lines 23 to 26.

Then a plastic material is moulded around selected areas of said structure leaving between adjacent selected areas at least one gap 81, 82 bridged by said substantially flat conducting structure 1, so as to provide the structure illustrated in FIG. 3. As also illustrated in FIG. 3, the moulding of a plastic material around selected areas of said structure may leave further parts 3, 4, 5, 21, 22, 41-45 and 51-55 of said substantially flat conducting structure protruding from said areas. As can be seen in FIG. 5 also the further parts, which are to form the fixed contacts 31-33 of the rocker switch are left protruding from the plastic material.

After the moulding, the conductive structure is severed from the blank, thereby obtaining the situation of FIG. 4.

Having finished the moulding and severing processes, the situation in FIG. 9 is obtained by permanently deforming said substantially flat structure by bending it along said at least one gap 81, 82. As will be noted, in the illustrated exemplary embodiment also some of the further parts 21, 22 are permanently deformed to form tabs for contacting and holding a battery, whereas other parts 41-45 and 52-54 are deformed, and connecting bridges 3, 4 and 5 cut away in order to leave connection pads.

The carrier element formed from the conductive structure 1 may be subjected to other finishing processes, e.g. surface treatment for surface protection, and will then finished as such, and can be fitted with the electronics module 85 and the rocker 86 carrying the contact bridge of the rocker switch to form a finished assembly, as illustrated in FIG. 10. The finished assembly carries all the necessary electronics for the hearing aid and needs only to be connected to input and output transducers, as far as the latter are not already located on the electronics module 85. Thereby a substantial reduction in the wiring work is obtained.

The finished assembly may then be fitted with a right shell 87a and a left shell 87b, guided by respective projections 91, 92, 93, 94 95, and 96, and other parts to generally provide the hearing aid housing as illustrated in FIGS. 11 and 12. In the assembled hearing aid of FIG. 12 is illustrated a battery compartment 89. This battery compartment may pivot about an axis located in a recess 90 in the shell 87a of the hearing aid housing and a corresponding recess (not visible) in inner surface of the shell 87b. This pivoting motion allows the battery located in the battery compartment to perform on/off switching of the hearing aid by engaging or disengaging, respectively, the battery tabs 21 and 22 of the carrier element. The carrier element thus incorporates all the fixed contacts of the various switches of the hearing aid, i.e. on/off switch, programme selector switch and volume up/down switch.

The skilled person will appreciate that further steps may precede, succeed or be interposed between the steps mentioned above without departing from the scope of the claims.

Moreover, the skilled person will appreciate that depending on the configuration of the hearing aid with which the carrier element according to the present invention is to be used, other configurations than the one of the illustrating embodiment can be utilised, without departing form the scope of the claims.

I claim:

1. A method for manufacturing a carrier element for a hearing aid, said method comprising the steps of
a) providing a substantially flat conducting structure,
b) moulding a plastic material around selected areas of said structure leaving at least one gap bridged by said substantially flat conducting structure, and
c) permanently deforming said substantially flat structure by bending it along said at least one gap.

2. The method according to claim 1, wherein said moulding of a plastic material around selected areas of said structure leaves a further part of said substantially flat conducting structure protruding from at least one of said areas.

3. The method according to claim 2, wherein said further part is permanently deformed to form a tab for contacting and holding a battery.

4. The method according to claim 2, wherein said further part is permanently deformed to form a connection pad.

5. The method according claim 1, further comprising the preceding step of forming said substantially flat structure from a blank by etching.

6. A carrier element for a hearing aid manufactured by providing a substantially flat conducting structure, moulding a plastic material around selected areas of said structure leaving at least one gap bridged by said substantially flat conducting structure, and permanently deforming said substantially flat structure by bending it along said at least one gap.

7. The carrier element according to claim 6, comprising a further part of said substantially flat conducting structure protruding from at least one of said areas and arranged so as to form a fixed contact of a switch.

8. The carrier element according to claim 6, wherein said plastic material around at least one of said selected areas of the structure comprises a plane surface.

9. The carrier element according to claim 6, wherein said plastic material around at least one of said selected areas of the structure comprises a surface provided with recesses exposing partially said conducting structure.

10. The carrier element according to claim 6, wherein said plastic material around at least one of said selected areas of the structure comprises a fulcrum for a switch operating element.

11. The carrier element according to claim 6, wherein said plastic material around at least one of said selected areas of the structure comprises a surface adapted to form part of the housing of a hearing aid.

12. The carrier element according to claim 6, wherein at least one connection pad is arranged in the vicinity of the plane surface so as to allow it to contact a terminal of an electronics module mounted on said surface.
